(19) United States
(12) Patent Application Publication
(10) Pub. No.: US 2025/0156347 A1
(43) Pub. Date: May 15, 2025

(54) Peer-To-Peer Communication Using Drain Buffers In Multi-Function Device

(71) Applicant: Western Digital Technologies, Inc., San Jose, CA (US)

(72) Inventor: Shay BENISTY, Beer Sheva (IL)

(73) Assignee: Western Digital Technologies, Inc., San Jose, CA (US)

(21) Appl. No.: 18/506,281

(22) Filed: Nov. 10, 2023

(51) Int. Cl. G06F 13/16; G06F 13/28; G06F 13/42

(52) U.S. Cl. CPC G06F 13/1673; G06F 13/287; G06F 13/4221

(57) ABSTRACT

Instead a having a system that lacks command draining, add a drain buffer to the solid state drive (SSD) to optimize command usage. By adding a drain buffer per physical function (PF) or virtual function (VF) and utilizing logic that can generate traffic, the controller is able to funnel packets to a host if the packet is not needed. The controller will change the original address of the packet to a different address. The controller will then send that packet with the different address through the host and back to the memory device. The packet will be in a different function, but the controller will know not to access the packet or ignore the packet. Ignoring the packet will act as a drain for the SSD. The controller PCIe packets draining occur in special flows, dummy traffic generation for PCIe attribute measurements, and internal events posting over the host/device interface.

### BACKGROUND OF THE DISCLOSURE

### Field of the Disclosure

Embodiments of the present disclosure generally relate to improving optimization of a drain buffer.

### Description of the Related Art

The Peripheral Component Interconnect express (PCIe) specification allows for peer-to-peer transactions. This means that it is possible and even desirable in some cases for one PCIe endpoint (e.g., Virtual Function or standard PCIe Function) to send data directly to another endpoint without having to go through the root complex. Access Control Services (ACS) provides a mechanism by which a peer-to-peer PCIe transaction can be forced to go up through the PCIe root complex. The ACS can be thought of as a kind of gate keeper, such as preventing unauthorized transactions from occurring.

Without ACS, there is the possibility for a PCIe endpoint to either accidentally or intentionally (i.e., maliciously) write to an invalid/illegal area on a peer endpoint, potentially causing problems. Even with ACS a solid state drive (SSD) still has a burden of command or packet build up. There is no efficient way to rid a system of command not need to be accessed.

Therefore, there is a need in the art for improving peer-to-peer PCIe transactions in multi-function device using drain buffers.

### SUMMARY OF THE DISCLOSURE

Instead a having a system that lacks command draining, add a drain buffer to the solid state drive (SSD) to optimize command usage. By adding a drain buffer per physical function (PF) or virtual function (VF) and utilizing logic that can generate traffic, the controller is able to funnel packets to a host if the packet is not needed. The controller will change the original address of the packet to a different address. The controller will then send that packet with the different address through the host and back to the memory device. The packet will be in a different function, but the controller will know not to access the packet or ignore the packet. Ignoring the packet will act as a drain for the SSD. The controller PCIe packets draining occur in special flows, dummy traffic generation for PCIe attribute measurements, and internal events posting over the host/device interface.

In one embodiment, a data storage device comprises: a memory device; and a controller coupled to the memory device, wherein the controller is configured to: generate traffic towards a host device; active a direct memory access (DMA) module; determine that a packet should be drained; replace host address with a drain buffer address to create a modified packet; route the modified packed to a drain buffer; and drain the modified packet.

In another embodiment, a data storage device comprises: a memory device; and a controller coupled to the memory device, wherein the controller is configured to: generate one or more dummy packets for a first function; transmit the one or more dummy packets over an interface to a host device; reroute the one or more dummy packets to a second function; and measure attributes of the one or more dummy packets.

In another embodiment, a data storage device comprises: means to store data; and a controller coupled to the means to store data, wherein the controller is configured to: generate regular host traffic and internal events for a first function; transmit the regular host traffic and internal events over an interface to a host device; and route the internal events to a second function.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic diagram illustrating a system for peer-to-peer PCIe transactions, according to one embodiment.

FIG. 3 is a schematic diagram illustrating a system for peer-to-peer multi-function PCIe transactions, according to one embodiment.

FIG. 4 is a schematic diagram illustrating a system for a memory device PCIe memory space including drain buffers, according to certain embodiments.

FIG. 5 is a block diagram illustrating a system a memory space, according to certain embodiments.

FIG. 6 is a flowchart illustrating a method for packet draining in special flows, according to certain embodiments.

FIG. 7 is a schematic diagram illustrating a system for internal event posting over host interface, according to certain embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Instead a having a system that lacks command draining, add a drain buffer to the solid state drive (SSD) to optimize command usage. By adding a drain buffer per physical function (PF) or virtual function (VF) and utilizing logic that can generate traffic, the controller is able to funnel packets to a host if the packet is not needed. The controller will change the original address of the packet to a different address. The controller will then send that packet with the different address through the host and back to the memory device. The packet will be in a different function, but the controller will know not to access the packet or ignore the packet. Ignoring the packet will act as a drain for the SSD. The controller PCIe packets draining occur in special flows, dummy traffic generation for PCIe attribute measurements, and internal events posting over the host/device interface.

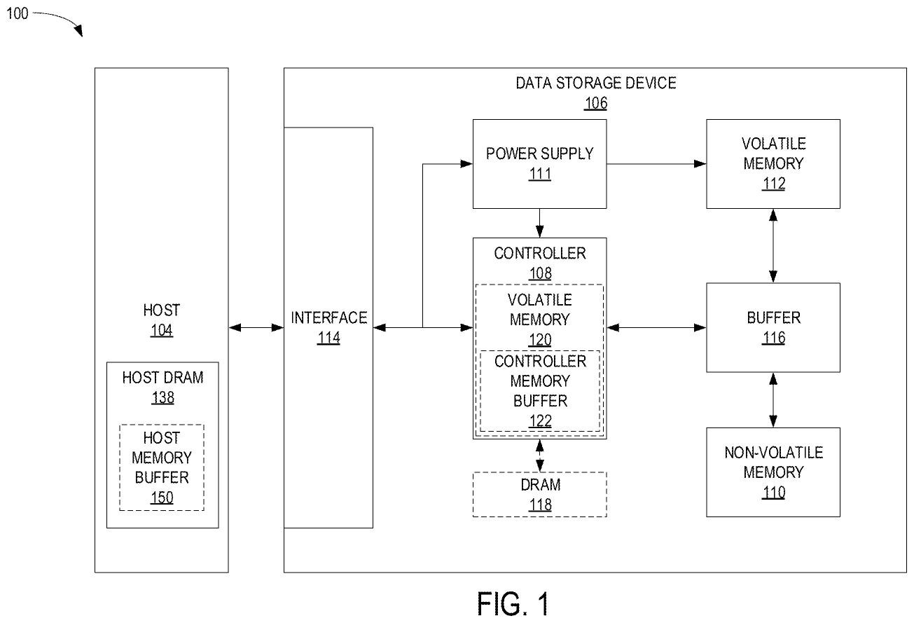

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

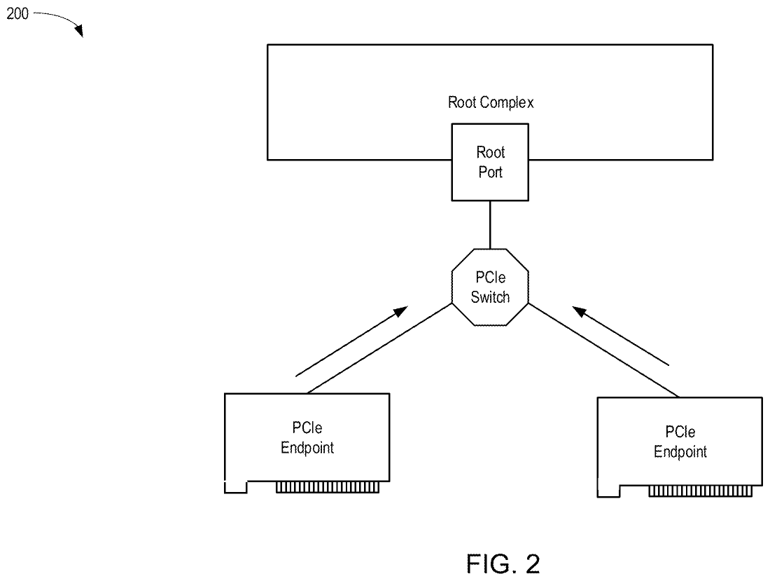

FIG. 2 is a schematic diagram illustrating a system 200 for peer-to-peer PCIe transactions, according to one embodiment. The system 200 incudes a root complex, a root port, a switch, and two PCIe endpoints. One PCIe endpoint issues a transaction towards the other PCIe endpoint. This is allowed when the feature is enabled through ACS capability in the initialization phase.

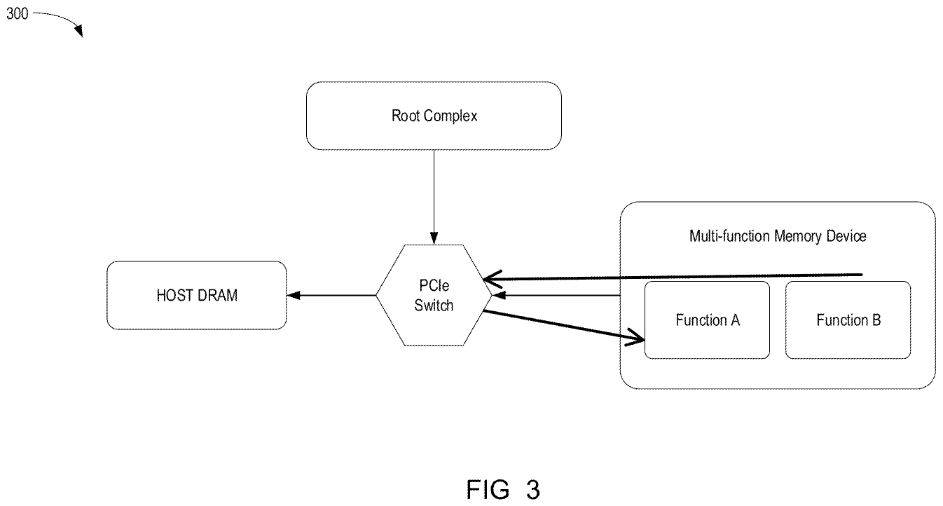

FIG. 3 is a schematic diagram illustrating a system 300 for peer-to-peer multi-function PCIe transactions, according to one embodiment. The system 300 includes a root complex, a PCIe switch, a host memory (e.g., DRAM), and a multi-function memory device (e.g., PCIe endpoint). The multifunction memory device comprises a function A and a function B. Function B within the memory device sends a PCIe transaction towards the PCIe switch to communicate with function A. This is allowed when the feature is enabled through ACS capability in the initialization phase.

For example function B sends a packet towards the PCIe switch. The PCIe switch then understands that the packet has a specific location. The PCIe switch recognizes the packet is for function A, so the packet is sent across the PCIe bus to function A in the memory device. This same example can work for sending a packet from function A to function B.

As will be discussed herein, peer-to-peer PCIe transactions in a multi-function device using drain buffers is disclosed. The data storage device can generate traffic from one physical or virtual function towards a drain buffer of a different physical or virtual function within the same data storage device. This will be done by adding a drain buffer per physical or virtual function and logic that can generate the traffic. The PCIe packets can be drained in special flows, dummy traffic generation for PCIe attribute measurements can occur, and internal event posting over a host/device interface can occur. In so doing, operations are improved through simplification, visibility, and performance optimization.

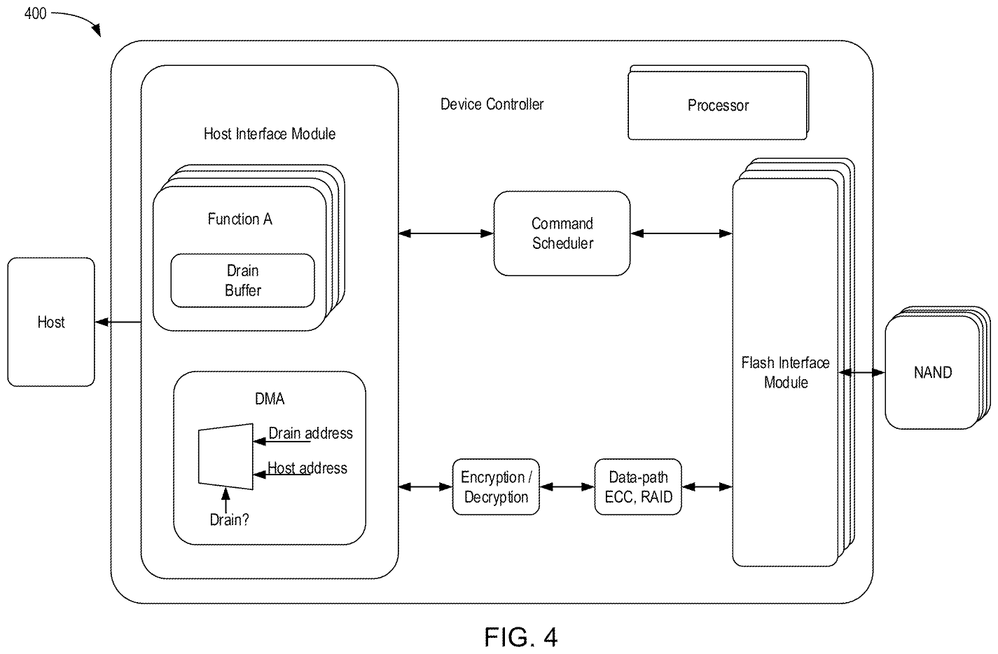

FIG. 4 is a schematic diagram illustrating a system 400 for a memory device PCIe memory space including drain buffers, according to certain embodiments. The system 400 comprises a host, a controller, and one or more memory devices (e.g., NAND). The controller further comprises a host interface module (HIM), a processor, a flash interface module (FIM), a command scheduler, an encryption/decryption module, and a data-path error correction code (ECC) RAID module. The HIM further comprises a plurality of functions with each function having a drain buffer, and a DMA with a multiplexer handling drain address and host addresses.

The multiplexer that will either send the original packet as usual towards the host. In drain mode, the controller will drain those packets replacing the original addresses from the host to the addresses of one of the drain buffers in another function. For each and every function in the device drain buffer will be implemented. The drain buffer is not a real buffer, but more of a memory space for each function. Each function has a drain buffer in order to receive those packets and this function will ignore the packets that are directed to this drain buffer.

Elements implemented in the system 400 include a drain buffer per physical or virtual function where each physical or virtual function implements a drain buffer. The drain buffers can be accessed through the PCIe bus. Write accesses are ignored while read accesses return zeroes. The size of each drain buffer is at minimal (e.g., 4 KB should be sufficient). There is an added capability of generating packets towards the drain buffers in the DMA. The drained buffers enable the DMA to transmit packets over the PCIe interface that will be ignored. Those ignored packets are very useful.

In another embodiment, the controller will flash all the pending packets (i.e., commands) that are in the device. Instead of sending the original addresses, the controller will replace the original addresses of the packets with dummy address. Once the packets are sent over the PCIe bus, the target of those destinations of those packets will be another function in the same device and the other function will be aware of those packets and will know to ignore the packets. This avoids killing the pipeline of specific packets, but rather just replacing the packets. Having this feature in the SSD simplifies the operations in some complex flows like reset, power, and abort flows. Using this feature, one function can drain all the pending PCIe transactions towards the other function without terminating transactions in the middle.

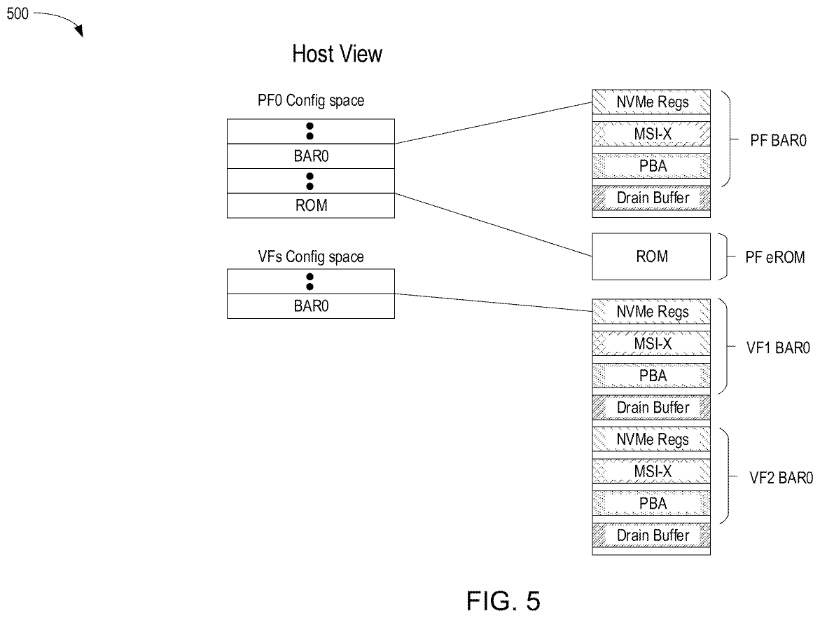

FIG. 5 is a block diagram illustrating a system 500 a memory space, according to certain embodiments. Each physical function (PF) or virtual function (VF) supported in the system 500 implements a drain buffer in BAR0 in this example. The drain buffer is not a real buffer. The drain buffer is just a memory space of 4 KB (for example). Any write to this location is ignored and any read returns zeros. The drained buffers are enabled to transmit packets over the PCIe interface that will be ignored. Those ignored packets are very useful.

In the memory provided, the PCI standard defines the BAR0. The BAR0 is the other space of the device. In this example the BAR0 has the NVMe registers, the MSI-X for interrupts, the PBA for interrupts, and the drain buffer. If the host accesses this address and this is the main buffer, this specific function will know to ignore all the packets that are directed to this buffer. This is for PF0 configured space.

The same can be true for all VFs or even PFs that are supported. For VF configured space, there is again the NVMe registers, the MSI-X, the PBA, and the drain buffers. There will be a PBA and a drain buffer for each and every function in this system 500. Whenever the host accesses the buffer, the function will know to just ignore the packets are directed to the buffer.

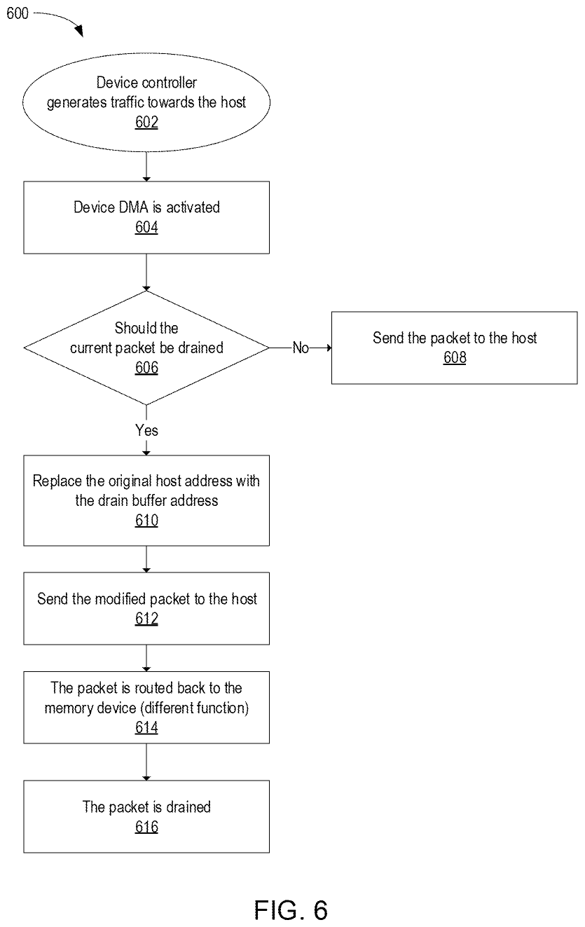

FIG. 6 is a flowchart illustrating a method 600 for packet draining in special flows, according to certain embodiments. The flowcharts starts by generating traffic on the host interface by activating the DMA residing in the device. In normal scenarios, the transactions are posted to the host without any modification. However, in special flows such as exceptions, abort, and reset, the packets are modified before the transfer to the host. The modification is done in the address of the packets. The original address is replaced by a drain buffer address associated with a different function. The modified packets are transmitted to the host. The switch routes those packets back to the device towards the drain buffer. Finally, the packet is drained and the exception scenario is completed without a special and complex treatment.

The method 600 begins at block 602. At block 602, the controller generates traffic towards the host. At block 604, the device DMA is activated. At block 606, the controller determines whether the current packet should be drained. If the controller determines that the current packet should not be drained, then the method 600 proceeds to block 608. At block 608, the controller sends packet to the host. If the controller determines that the current packet should be drained, then the method 600 proceeds to block 610. At block 610, the controller replaces the original host address with the drain buffer address. At block 612, the controller sends the modified packet to the host. At block 614, the controller routes the packet back to the memory device (different function). At block 616, the controller drains the packet.

In another embodiment, the controller generates dummy packets towards one of the drain buffers supported by the other functions. The controller measures the attributes of those packets such as latency and performance to better understand the PCIe topology of this specific system. Based on this exercise, the controller may adapt and fine-tune the used PCIe attributes to maximize the performance and QoS.

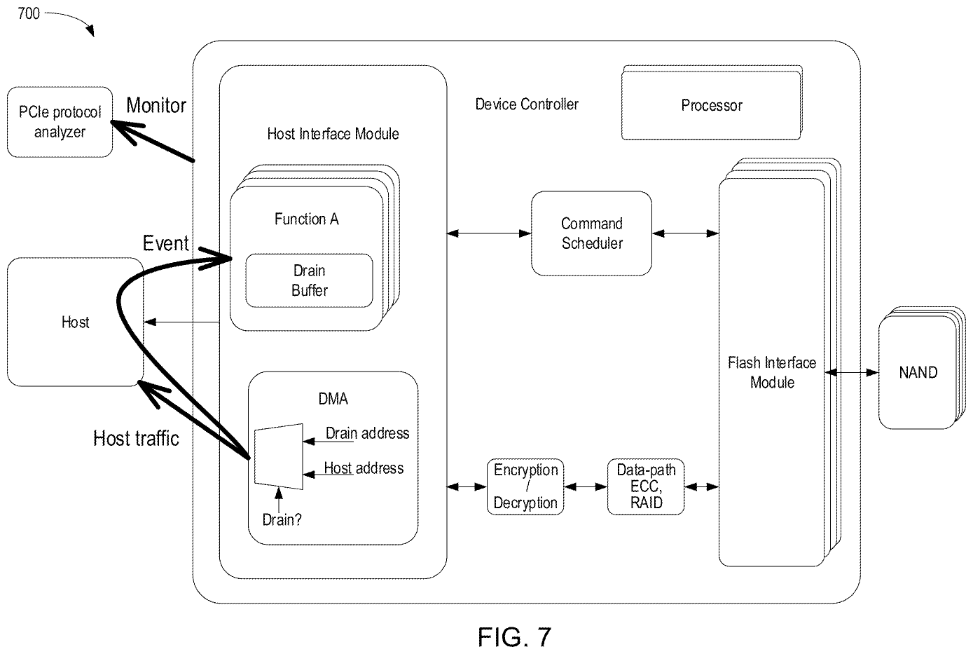

FIG. 7 is a schematic diagram illustrating a system 700 for internal event posting over host interface, according to certain embodiments. The device controller generates both regular host traffic and internal events to transmit both over the host interface. The internal events are routed towards one of the drain buffers supported by the other functions. The transactions are transparent to the rest of the system 700, but will help to provide better visibility in failure cases. The regular host traffic is routed towards the host or host DRAM while the internal events are routed back to the device but to a different function. The packets are drained in the target function. The traffic is monitored using the PCIe protocol analyzer and the internal events provides more visibility and help the controller to debug this system 700.

In order to have better performance, the debug events are sent over the PCIe interface and the destination of those debug events will be the other function. The drain buffering of the other function is so that the other function will know to ignore those packets. The benefit here is that a protocol analyzer can be connected to the bus and monitor those events. This will give small visibility about what happened internally in the device controller.

In another embodiment, the controller generates both regular host traffic and internal events and transmit them over the host interface. The internal events are routed towards one of the drain buffers supported by the other functions. The transactions are transparent to rest of the system 700, but will help to provide better visibility in failure cases.

The advantage of having a drain buffer in the SSD simplifies the operations in some complex flows like reset, power, and abort flows. Using the drain buffer, one function can drain all the pending PCIe transactions towards the other function without terminating those transactions in the middle. This feature further allows the SSD to send some debug events over the PCIe interface so there is better visibility which eases the debug process. This feature further allows the SSD to send dummy transactions over the PCIe, which will be drained later. The SSD can use those transactions to measure the used PCIe topology in the system and fine-tune the configuration to optimize the performance and quality of service (QOS).

In one embodiment, a data storage device comprises: a memory device; and a controller coupled to the memory device, wherein the controller is configured to: generate traffic towards a host device; active a direct memory access (DMA) module; determine that a packet should be drained; replace host address with a drain buffer address to create a modified packet; route the modified packed to a drain buffer; and drain the modified packet. The controller is configured to send the modified packet to the host device prior to the routing. The sending occurs over a peripheral component interconnect express (PCIe) bus. The packet is from a first virtual function. The modified packet is routed to a second virtual function different from the first virtual function. The controller includes at least one of the following: one or more virtual functions disposed in a host interface module (HIM); or one or more physical functions. Each virtual function or physical function includes a corresponding drain buffer. The HIM further includes the DMA module, and wherein the DMA module includes a multiplexer. The controller is configured to ignore the modified packet for write access. The controller is configured to return all zeros for the modified packet for read access. The packet is for a special flow and wherein the special flow is selected from the group consisting of exception flows, abort flows, and reset flows. The controller is further configured to measure attributes of the modified packets. The controller is further configured to: generate both regular host traffic and internal events; and transmit the regular host traffic and internal events over an interface to the host device.

In another embodiment, a data storage device comprises: a memory device; and a controller coupled to the memory device, wherein the controller is configured to: generate one or more dummy packets for a first function; transmit the one or more dummy packets over an interface to a host device; reroute the one or more dummy packets to a second function; and measure attributes of the one or more dummy packets. The attributes are selected from the group consisting of latency, performance, and combinations thereof. The first function and the second function each contain a drain buffer. The rerouting is to the drain buffer of the second function.

In another embodiment, a data storage device comprises: means to store data; and a controller coupled to the means to store data, wherein the controller is configured to: generate regular host traffic and internal events for a first function; transmit the regular host traffic and internal events over an interface to a host device; and route the internal events to a second function. The routing is to a drain buffer of the second function. The generating, transmitting, and routing are transparent to a remainder of the data storage device.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
generate traffic towards a host device;
active a direct memory access (DMA) module;
determine that a packet should be drained;
replace host address with a drain buffer address to create a modified packet;
route the modified packed to a drain buffer; and
drain the modified packet.

2. The data storage device of claim 1, wherein the controller is configured to send the modified packet to the host device prior to the routing.

3. The data storage device of claim 2, wherein the sending occurs over a peripheral component interconnect express (PCIe) bus.

4. The data storage device of claim 1, wherein the packet is from a first virtual function.

5. The data storage device of claim 4, wherein the modified packet is routed to a second virtual function different from the first virtual function.

6. The data storage device of claim 1, wherein the controller includes at least one of the following:
one or more virtual functions disposed in a host interface module (HIM); or
one or more physical functions.

7. The data storage device of claim 6, wherein each virtual function or physical function includes a corresponding drain buffer.

8. The data storage device of claim 7, wherein the HIM further includes the DMA module, and wherein the DMA module includes a multiplexer.

9. The data storage device of claim 1, wherein the controller is configured to ignore the modified packet for write access.

10. The data storage device of claim 1, wherein the controller is configured to return all zeros for the modified packet for read access.

11. The data storage device of claim 1, wherein the packet is for a special flow and wherein the special flow is selected from the group consisting of exception flows, abort flows, and reset flows.

12. The data storage device of claim 1, wherein the controller is further configured to measure attributes of the modified packets.

13. The data storage device of claim 1, wherein the controller is further configured to:
generate both regular host traffic and internal events; and
transmit the regular host traffic and internal events over an interface to the host device.

14. A data storage device, comprising:
a memory device; and
a controller coupled to the memory device, wherein the controller is configured to:
generate one or more dummy packets for a first function;
transmit the one or more dummy packets over an interface to a host device;
reroute the one or more dummy packets to a second function; and
measure attributes of the one or more dummy packets.

15. The data storage device of claim 14, wherein the attributes are selected from the group consisting of latency, performance, and combinations thereof.

16. The data storage device of claim 14, wherein the first function and the second function each contain a drain buffer.

17. The data storage device of claim 16, wherein the rerouting is to the drain buffer of the second function.

18. A data storage device, comprising:
means to store data; and
a controller coupled to the means to store data, wherein the controller is configured to:
generate regular host traffic and internal events for a first function;
transmit the regular host traffic and internal events over an interface to a host device; and
route the internal events to a second function.

19. The data storage device of claim 18, wherein the routing is to a drain buffer of the second function.

20. The data storage device of claim 19, wherein the generating, transmitting, and routing are transparent to a remainder of the data storage device.
